(19) United States
(12) Patent Application Publication
(10) Pub. No.: US 2004/0201540 A1
(43) Pub. Date: Oct. 14, 2004

(54) Electromagnetic protection antenna for protable transmitter

(76) Inventor: Abel Franco, Kissimmee, FL (US)

Correspondence Address: YOUNG & THOMPSON, 745 SOUTH 23RD STREET 2ND FLOOR, ARLINGTON, VA, 22202

(21) Appl. No.: 10/482,290

(22) PCT Filed: Jul. 2, 2002
(86) PCT No.: PCT/EP02/08675

(30) Foreign Application Priority Data
Jul. 2, 2001 (FR) 01/08726

(51) Int. Cl. H01Q 21/00

(52) U.S. Cl. 343/867; 343/742

(57) ABSTRACT

An electromagnetic protection antenna for mobile transmitter, includes two substantially planar loops (1, 2) symmetrical relative to an electrically insulated intersecting point. A central antenna (5, 6) is arranged inside each of the loops, each central antenna having a shape substantially homothetic with that of the respective loop.

The present invention relates to an antenna providing electromagnetic protection for a mobile transmitter, for example a mobile phone, and more especially to this type of antenna comprising two substantially planar loops, which are symmetrical relative to an electrically insulated intersecting point, so as to ensure a phase difference between the two loops.

These types of antennae are already known in FR-A 2 781 088. Although providing satisfaction in general, it has been noted that this type of antenna could be improved so as to make the protection given to the user more effective.

The present invention intends to supply an antenna of the abovementioned type that is much more efficient.

To this end, the object of the invention is an antenna providing electromagnetic protection for a mobile transmitter, said antenna being of the type comprising two loops which are substantially planar and symmetrical relative to an electrically insulated intersecting point, characterised in that a central antenna is disposed inside each of the loops, each central antenna having a shape which is substantially homothetic relative to that of the respective outside loop.

In a specific embodiment, the dimensions of each central antenna are substantially half of that of the respective outside loop.

In addition, in a specific embodiment, each central antenna forms an open loop.

In addition, in a specific embodiment, each central antenna is connected electrically to the respective loop by a connecting section.

More especially, each of the said connecting sections can be orientated in a radial manner with respect to the point of symmetry.

More especially also, the opening in each of the central antennae can be situated substantially opposite the point of contact of the said central antenna with the said connecting section.

A specific embodiment of the invention is now described by way of a non-restrictive example, referring to the enclosed schematic drawings, in which:

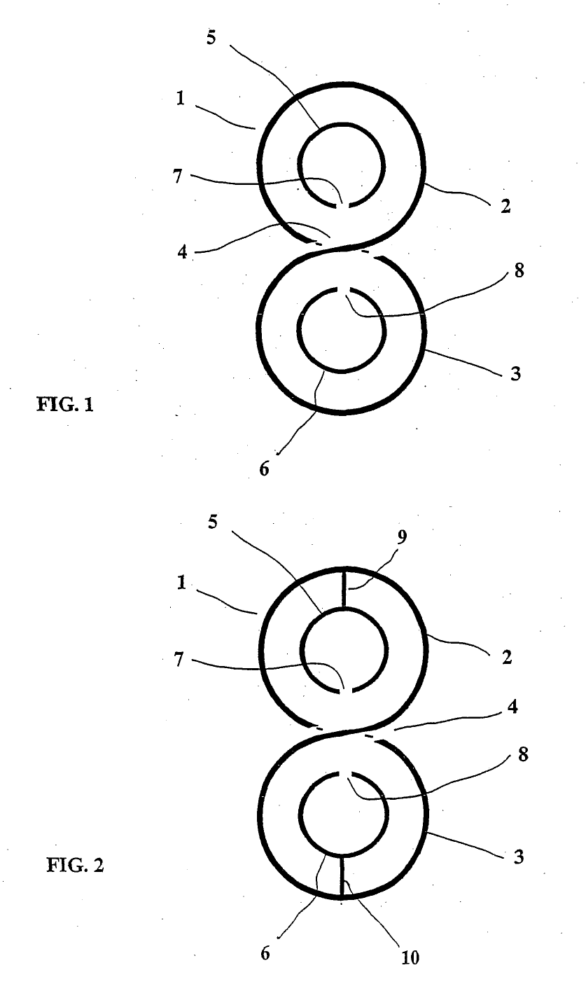

FIG. 1 is a plan view of an antenna according to a first embodiment of the invention,

FIG. 2 is a plan view of another embodiment,

FIG. 1 shows an antenna 1 comprising two circular loops 2 and 3, which intersect at a point 4 relative to which they are symmetrical. The intersection of the two loops at the point 4 is effected in such a manner that the two branches are electrically insulated.

A central antenna 5 and 6 is disposed inside each loop 2 and 3 respectively. The central antennae 5 and 6 are also circular and their diameter is substantially equal to half the diameter of the loops 2 and 3.

Each central antenna 5 and 6 is open at a point 7 and 8 respectively, which, in this case, is the point of each antenna nearest to the point of intersection 4. Consequently, the points 4, 7 and 8 are aligned in this case.

The same references are used in FIGS. 1 and 2 for homologous elements.

The embodiment in FIG. 2 differs from that in FIG. 1 by the fact that each central antenna 5 and 6 is electrically connected to the loop inside which it is disposed, by a connecting section 9 and 10 respectively.

The connecting sections 9 and 10, in this case, are rectilinear and are aligned with the point of intersection 4. Consequently, the connecting sections 9 and 10 connect to the central antennae 5 and 6 at their point opposite their opening point 7 and 8 respectively.

The Figures show the antenna loops, and consequently the central circular antennae. Any other shape of closed antenna could obviously be envisaged, for example square, triangular or diamond shapes.

All the antenna wiring can be effected for example by copper deposit, in any known manner, on a flat substrate provided with an adhesive allowing it to be secured on a portable electromagnetic transmitter, for example, a mobile phone, or any other type of transmitter.

1. Antenna providing electromagnetic protection for a mobile transmitter, said antenna being of the type comprising two loops (1, 2) which are substantially planar and symmetrical relative to an electrically insulated intersecting point (4), characterised in that a central antenna (5, 6) is disposed inside each of the loops, each central antenna having a shape which is substantially homothetic relative to that of the respective loop.

2. Antenna according to claim 1, in which the dimensions of each central antenna are substantially half of that of the respective loop.

3. Antenna according to claim 1, in which each central antenna forms an open loop.

4. Antenna according to claim 3, in which each central antenna is electrically connected to the respective loop by a connecting section (9, 10).

5. Antenna according to claim 4, in which each of the said connecting sections is orientated in a radial manner with respect to the point of symmetry.

6. Antenna according to claim 4, in which the opening (7, 8) in each of the central antennae is situated substantially opposite the point of contact of the said central antenna with the said connecting section.

7. Antenna according to claim 2, in which each central antenna forms an open loop.

8. Antenna according to claim 1, in which each central antenna is electrically connected to the respective loop by a connecting section (9, 10).

9. Antenna according to claim 2, in which each central antenna is electrically connected to the respective loop by a connecting section (9, 10).

10. Antenna according to claim 8, in which each of the said connecting sections is orientated in a radial manner with respect to the point of symmetry.

11. Antenna according to claim 9, in which each of the said connecting sections is orientated in a radial manner with respect to the point of symmetry.
